(19) United States
(12) Patent Application Publication
(10) Pub. No.: US 2005/0016791 A1
(43) Pub. Date: Jan. 27, 2005

(54) Steering control system

(75) Inventors: Naoto Fukushima, Kanagawa (JP); Toshiaki Nakamura, Kanagawa (JP); Kohtaro Shiino, Kanagawa (JP); Satoshi Taniuchi, Kanagawa (JP); Kazuya Yamano, Kanagawa (JP); Minoru Masaki, Saitama (JP)

Correspondence Address: FOLEY AND LARDNER;SUITE 500, 3000 K STREET NW, WASHINGTON, DC, 20007, US

(73) Assignees: HITACHI UNISIA AUTOMOTIVE, LTD.; UNISIA JKC STEERING SYSTEMS CO., LTD.

(21) Appl. No.: 10/897,125

(22) Filed: Jul. 23, 2004

(30) Foreign Application Priority Data
Jul. 24, 2003 (JP) 2003-200820

(51) Int. Cl. B62D 5/06

(52) U.S. Cl. 180/446

(57) ABSTRACT

A steering control system for controlling turning of steered road wheels of a motor vehicle in accordance with steering of a steering wheel, comprises a steering angle sensor that detects a steering angle by which the steering wheel is turned; an actuator that turns the steered road wheels when operated; a vehicle operation condition sensor that detects an operation condition of the motor vehicle; a target value determining section that determines a steered angle target value of the steered road wheels in accordance with the steering angle detected by the steering angle sensor and the vehicle operation condition detected by the vehicle operation condition sensor; and an actuator drive circuit that drives the actuator in accordance with the steered angle target value.

### BACKGROUND OF THE INVENTION

1. Field of the Invention

The present invention relates in general to a control system of steering devices for wheeled motor vehicles, and more particularly to a steering control system of steer-by-wire type steering device wherein a steering wheel and steered road wheels are connected through an electronically controlled actuation system.

2. Description of the Related Art

In order to clarify the task of the present invention, a known steering control system of steer-by-wire type steering device will be briefly described, which is shown in Japanese Laid open Patent Application (Tokkai) 2000-6829.

In the steering control system of the publication, a torsion bar is interposed between a steering shaft on which a steering wheel is mounted and an input shaft to which a sun gear of a planetary gear unit is connected. Thus, when the steering wheel is turned, the torsion bar is twisted. The twisted degree (viz., torsional moment, or torque) of the torsion bar is detected by a potentiometer and inputted to a control unit. An output shaft from a ring gear of the planetary gear unit is connected to a rack-and-pinion mechanism, so that rotation of the output shaft induces a reciprocating movement of the rack bar of the rack-and-pinion gear mechanism. Each end of the rack bar is connected to one end of a tie rod. The other end of the tie rod is connected to a steered wheel through a knuckle arm. An electric actuator controlled by the control unit is incorporated with the ring gear of the planetary gear unit to assist output operation of the same. That is, when the steering wheel is turned and thus the torsion bar is twisted, the potentiometer detects the torsional moment (or torque) of the torsion bar, and information on the torsional moment (or torque) is fed to the control unit. By processing the information, the control unit controls the electric actuator so that a suitable assist force is applied to the output operation of planetary gear unit. With this, steering of the steered road wheels is carried out with a reduced force applied to the steering wheel from a driver.

### SUMMARY OF THE INVENTION

In the above-mentioned steering control system of the steer-by-wire type steering device, the toque detected by the potentiometer is used as a parameter for controlling the steering assist operation. This means that even if the driver turns the steering wheel for the purpose of turning the vehicle, the potentiometer can not sense the driver's intention so long as the torsion bar is not twisted. Of course, in this case, the steering operation is not assisted by the electric actuator due to production of such dead operation zone.

If such dead operation zone is produced, a precise assist control for the steered road wheels, such as a control effected in accordance with the moving condition (for example, yaw rate) of the motor vehicle, is not correctly carried out. That is, in such case, a control range for power-steering the steered road wheels is reduced inevitably.

Accordingly, the present invention aims to provide a steering control system of steer-by-wire type steering device, which is free of the above-mentioned shortcoming.

In accordance with a first aspect of the present invention, there is provided a steering control system for controlling turning of steered road wheels of a motor vehicle in accordance with steering of a steering wheel. The steering control system comprises a steering angle sensor that detects a steering angle by which the steering wheel is turned; an actuator that turns the steered road wheels when operated; a vehicle operation condition sensor that detects an operation condition of the motor vehicle; a target value determining section that determines a steered angle target value of the steered road wheels in accordance with the steering angle detected by the steering angle sensor and the vehicle operation condition detected by the vehicle operation condition sensor; and an actuator drive circuit that drives the actuator in accordance with the steered angle target value.

In accordance with a second aspect of the present invention, there is provided a steering control system of a steer-by-wire type steering device, the steering device including an electric motor for turning steered road wheels of a motor vehicle, and a torsion bar operatively interposed between a steering wheel and the steered road wheels. The steering control system comprises a vehicle speed sensor that detects a running speed of the vehicle; a steering angle sensor that detects a steering angle by which a steering wheel of the vehicle is turned; a steered angle sensor that detects a steered angle of steered road wheels of the vehicle; a torque sensor that detects a torque applied to the torsion bar; a first means that, by processing the running speed of the vehicle detected by the vehicle speed sensor and the steering angle detected by the steering angle sensor, outputs a steered angle target value signal that represents a steered angle target value of steered road wheels of the vehicle; a second means that, by processing the steered angle target value signal from the first means and the steered angle detected by the steered angle sensor, outputs a corrected steered angle signal that represents a corrected value of the steered angle of the steered road wheels of the vehicle, the corrected steered angle signal being fed to the electric motor for controlling the turning of the steered road wheels; and a third means that, by processing the torque detected by the torque sensor, produces a steering reaction force that is to be applied to the steering wheel.

### BRIEF DESCRIPTION OF THE DRAWINGS

Other objects and advantages of the present invention will become apparent from the following description when taken in conjunction with the accompanying drawings, in which:

FIG. 1 is a schematic view of a steering control system of a steer-by-wire type steering device, which is a first embodiment of the present invention;

FIG. 2 is a schematically illustrated sectional view of the steer-by-wire type steering device;

FIG. 3 is a block diagram of a control unit employed in the first embodiment of the present invention;

FIG. 4 is another schematic view of the steering control system of the first embodiment of the present invention;

FIG. 5 is a block diagram of a control unit employed in a second embodiment of the present invention;

FIG. 6 is a schematic view of a steer-by-wire type steering device, to which a steering control system of a third embodiment of the invention is practically applied; and

FIG. 7 is a schematic view of a steer-by-wire type steering device, which a steering control system of a fourth embodiment of the invention is practically applied.

### DETAILED DESCRIPTION OF THE EMBODIMENTS

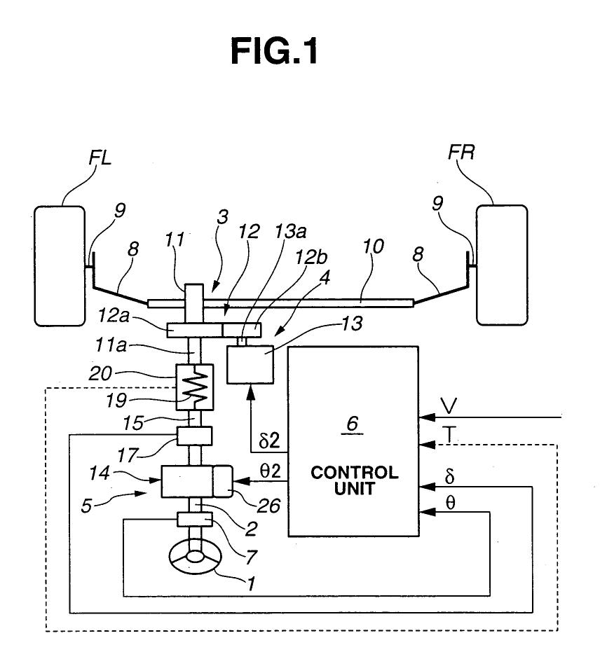

Referring to FIG. 1, there is schematically shown a steering control system of a steer-by-wire type steering device, which is a first embodiment of the present invention.

The steering device shown is constructed to steer front right and front left steered road wheels FR and FL with the aid of an assisting force in accordance with turning of a steering wheel 1.

The steering device generally comprises a steering shaft 2 that is connected to and driven by steering wheel 1, a rack-and-pinion mechanism 3 that actuates front right and front left steered road wheels FR and FL, a power steering section 4 that drives rack-and-pinion mechanism 3 in accordance with a steering angle by which steering shaft 2 is turned, a back-up steering section 5 that is operatively independent from power steering section 4 and drives rack-and-pinion mechanism 3 in accordance with the steering angle of steering shaft 2, and an electric control unit 6 that controls mainly power steering section 4 in accordance with the steering angle of steering shaft 2.

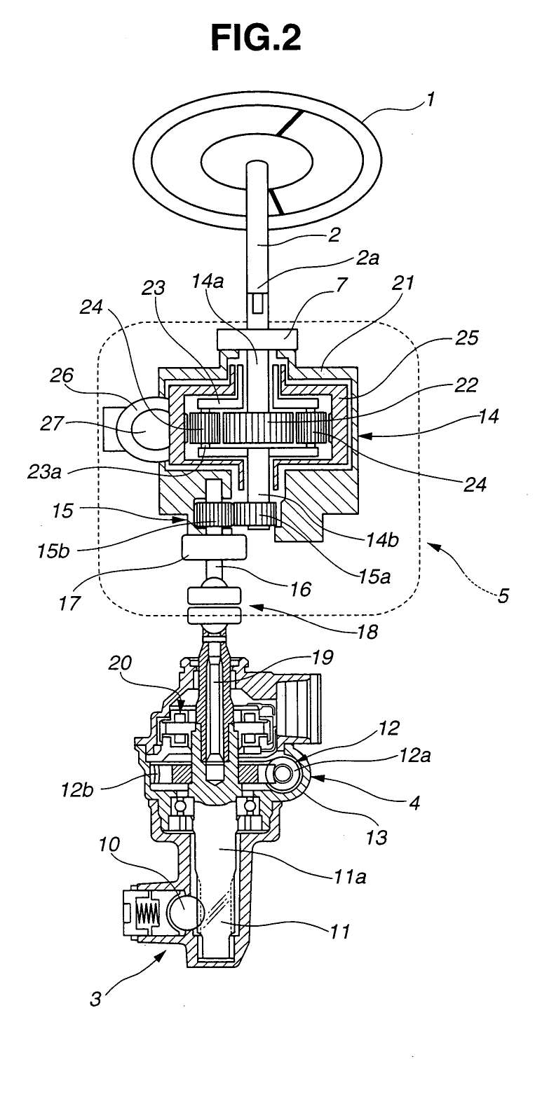

As is seen from FIGS. 1 and 2, steering shaft 2 is equipped with a steering angle sensor 7 that detects a steering angle by which steering wheel 1 is turned.

As is seen from FIG. 2, steering shaft 2 has a leading end 2a connected to an input shaft 14a of an after-mentioned planetary gear unit 14.

Referring back to FIG. 1, rack-and-pinion mechanism 3 comprises a rack bar 10 that has both ends each being connected to steered road wheel FR or FL through a tie rod 8 and a knuckle arm 9, and a pinion gear 11 that is meshed with rack bar 10.

As is seen from FIGS. 1 and 2, particularly from FIG. 2, power steering section 4 comprises a gear unit 12 that turns pinion gear 11 in one and other directions, and an electric motor 13 that drives the gear unit 12 in one and other directions with the aid of electric power. Gear unit 12 comprises a worm gear 12a that is mounted on an output shaft 13a of electric motor 13, and a worm wheel 12b that is mounted on a shaft 11a (see FIG. 2) of pinion gear 11 and meshed with worm gear 12a. As will be described in detail hereinafter, electric motor 13 is controlled to rotate in one and other directions in accordance with instruction signals from control unit 6.

As is shown in FIG. 2, back-up steering section 5 comprises a planetary gear unit 14 of which sun gear is connected to input shaft 14a, a lower shaft 16 that is connected to an output shaft 14b of planetary gear unit 14 through a gear unit 15, a steered angle sensor 17 that is mounted on lower shaft 16 to detect a steered angle of steered road wheels FR and FL and a torsion bar 19 that is arranged between steered angle sensor 17 and gear unit 12 and connected to lower shaft 16 through a joint 18.

Gear unit 15 comprises two mutually meshed spur gears 15a and 15b, spur gear 15a being connected to output shaft 14b of planetary gear unit 14, and the other spur gear 15b being connected to lower shaft 16, as shown.

As is seen from FIG. 2, torsion bar 19 has a lower end coaxially connected to shaft 11a of pinion gear 11, and a torque sensor 20 is arranged beside torsion bar 19 to detect a twisted degree (viz., torsional moment or toque) of torsion bar 19.

As will be described in detail hereinafter, the torsional moment sensed by torque sensor 20 is used for applying steering wheel 1 with a suitable steering reaction force (or steering load).

As is seen from FIG. 2, planetary gear unit 14 has a housing 21 and comprises a sun gear 22 that is integral with the above-mentioned input shaft 14a, a ring gear 25 that is concentrically arranged about sun gear 25 to define therebetween an annular clearance, and a plurality (for example, three) of planetary gears 24 that are received in the annular clearance to mesh with both sun gear 22 and ring gear 25 and held by a planetary carrier 23. For rotatably supporting planetary gears 24, planetary carrier 23 is formed with a plurality (for example, three) of shafts 23a, as shown.

Ring gear 25 is formed on its outer surface with a worm gear (not shown) that is meshed with a worm shaft 27 connected to an output shaft of an electric motor 26.

Output shaft 14b of planetary gear unit 14 is connected to lower shaft 16 through gear unit 15, so that rotation of output shaft 14b is transmitted to lower shaft 16.

Electric motor 26 is controlled to rotate in one and other directions in accordance with instruction signals from control unit 6. Upon rotation of electric motor 26, ring gear 25 and planetary gears 24 of planetary gear unit 14 are driven, so that a rotation ratio (viz., speed reduction ratio) between input and output shafts 14a and 14b is varied.

Control unit 6 has a microcomputer that includes CPU, RAM, ROM and input and output interfaces. The control executed by control unit 6 is as follows.

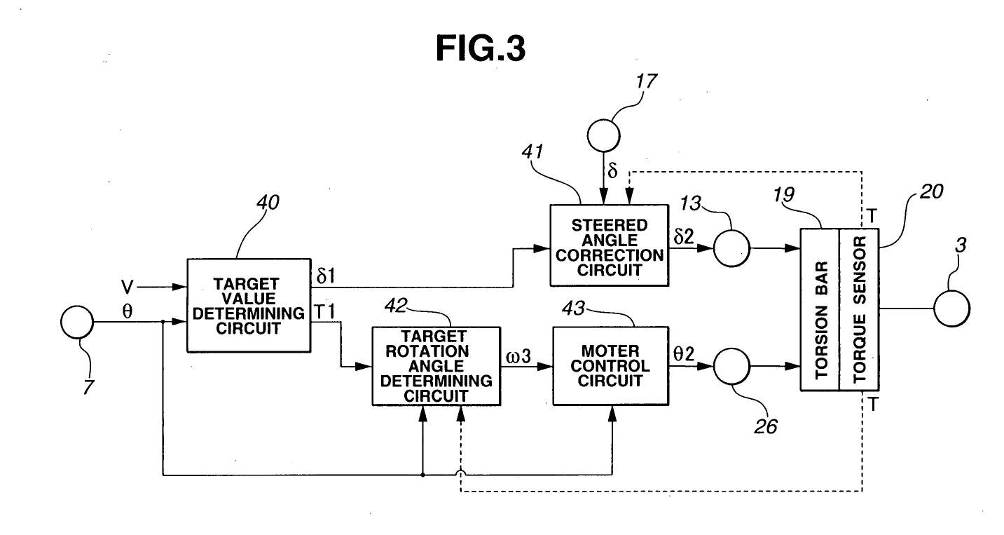

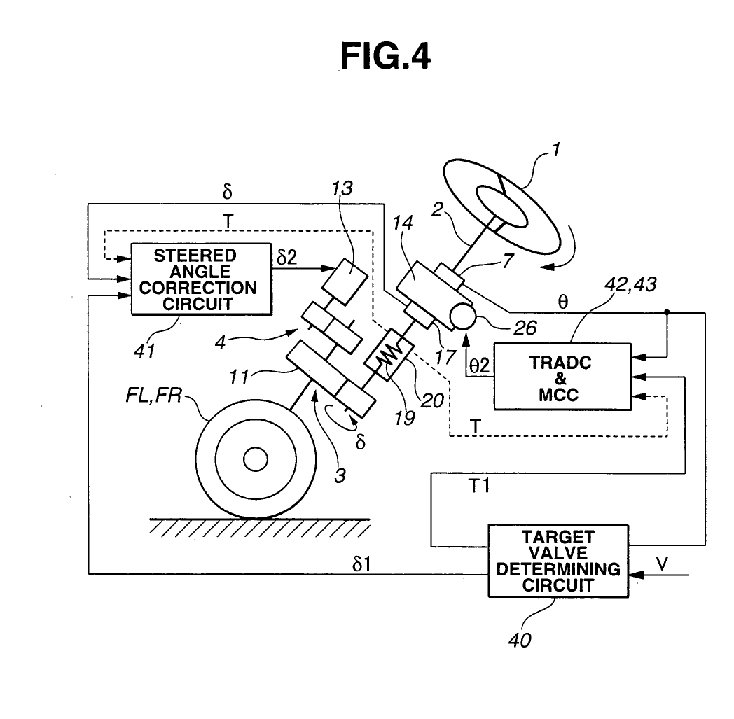

As is seen from FIGS. 3 and 4, control unit 6 comprises a target value determining circuit 40 that, by processing a vehicle speed signal “V” detected by a vehicle speed sensor (not shown) and a steering angle signal “θ” detected by steering angle sensor 7, outputs both a steered angle target value “δ1” and a steering reaction force target value “T1”, a steered angle correction circuit 41 that, by processing the steered angle target value “δ1” and a real steered angle signal “δ” from steered angle sensor 17, outputs a corrected steered angle signal “δ2” to electric motor 13. If desired, a torque signal “T” from torque sensor 20 may be fed to steered angle correction circuit 41. Upon receiving the corrected steered angle signal “δ2”, electric motor 13 is operated to adjust the steered angle of front right and front left steered road wheels FR and FL through torsion bar 19 and rack-and-pinion mechanism 3. With this, front right and front left steered road wheels FR and FL are turned by electric motor 13 in accordance with turning of steering wheel 1.

Control unit 6 further comprises a target rotation angle determining circuit (or TRADC) 42 that, by processing steering reaction force target value “T1” and steering angle signal “θ”, outputs an angular speed “ω3” for ring gear 25 of planetary gear unit 14, and a motor control circuit (or MCC) 43 that, by processing angular speed “ω3” and steering angle signal “θ”, outputs a rotation angle “θ2” of output shaft 14b to electric motor 26. If desired, toque signal “T” from torque sensor 20 may be fed to target rotation angle determining circuit 42. Upon receiving a signal representing rotation angle “θ2” from motor control circuit 43, electric motor 26 is operated to control the steered angle of front right and front left steered road wheels FR and FL through torsion bar 19 and rack-and-pinion mechanism 3.

The control of steering reaction force applied to steering wheel 1 is carried out by adjusting rotation angle “θ2” of output shaft 14b in accordance with the real steered angle “δ”.

An appropriate steering reaction force (T1) that is fed back to steering wheel 1 from planetary gear unit 14 through torsion bar 16 can be derived from the following equations.

It is now to be noted that “θ” is a steering angle detected by steering angle sensor 7, “δ” is a real steered angle of steered road wheels FR and FL detected by steered angle sensor 17, “δ1” is a target value for the real steered angle “δ”, “ω1” is an input rotation angular speed of steering shaft 2 (viz., steering angular speed) relative to planetary gear unit 14, “ω2” is an output shaft rotation angular speed (viz,, real steered angular speed) of planetary gear unit 14, “ω3” is a target value of rotation angular speed of ring gear 25 of planetary gear unit 14, “θ2” is a rotation angle of output shaft 14b of planetary gear unit 14, “θ3” is a target value for rotation angle “θ2” of output shaft 14b, “T” is a torsional moment (or torque) of torsion bar 19, “T1” is a target value of steering reaction force and “K” is a rigidity factor of torsion bar 19.

The relation between the real steered angle “δ” and values represented by information signals from various sensors is represented by the following equation.
δ=θ2+T/K (1)
wherein:
T/K : twisted degree of torsion bar 19

Due to work of steered angle correction circuit 41, the real steered angle “α” of road wheels FL and FR is set to an instruction value “α1”. That is, “α=α1” is established.

Accordingly, the rotation angle target value “θ3” of output shaft 14b for achieving the steering reaction force target value “T1” is obtained from the following equation.
θ3=δ−T1/K (2)
Δθ2=74 3−θ2=(T −T1)/K (3)

Thus, the control should be so made as to follow the following equation.
ω2=αΔθ2=α(T−T1)/K (4)
wherein:
α: gain

By using the above, a target value of rotation angular speed of the output shaft of electric motor 26, that is, the target value “ω3” of rotation angular speed of ring gear 25 is represented by the following equation:
ω3=(ω1+α(T−T1)/K)/Z (5)
wherein:
Z: speed reduction ratio set between output shaft 14b and ring gear 25.

It is to be noted that rigidity factor “K” of torsion bar 19 is so determined as make the control ideal.

As is understood from the above description, the steering control for steered road wheels FL and FR according to the present invention does not depend on the torsional moment (viz., torque) applied to torsion bar 19. This means that the flexibility of steering control for the steered road wheels FR and FL is increased unlike in case of the known control of the afore-mentioned Japanese Laid-open Patent Application (Tokkai) 2000-6829.

Furthermore, the reaction force of steering wheel 1 is suitably controlled without being affected by disturbance from the steered road wheels FR and FL. That is, under turning of steering wheel 1, the steering control to the wheels FR and FL is mainly carried out by power steering section 4. That is, the reaction force of the wheels FR and FL is transmitted to steering wheel 1 through torsion bar 19 from back-up steering section 5. Thus, during the reaction force transmission to steering wheel 1, torsion bar 19 is twisted by a certain degree to dampen shocks (or disturbance) that would be transmitted from the road wheels FR and FL to steering wheel 1.

Even if power steering section 4 fails to operate, the turning of steering wheel 1 is assuredly transmitted to rack-and-pinion 3 through planetary gear unit 14 and torsion bar 19. This means that even if power steering section 4 fails to operate, no harmful influence is applied to back-up steering section 5. That is, even if power steering section 4 fails to operate, a so-called “fail-safe” operation is achieved in the present invention.

When power steering section 4 operates normally, the above-mentioned steering assist operation is carried out with the aid of electric motor 26 and planetary gear unit 14.

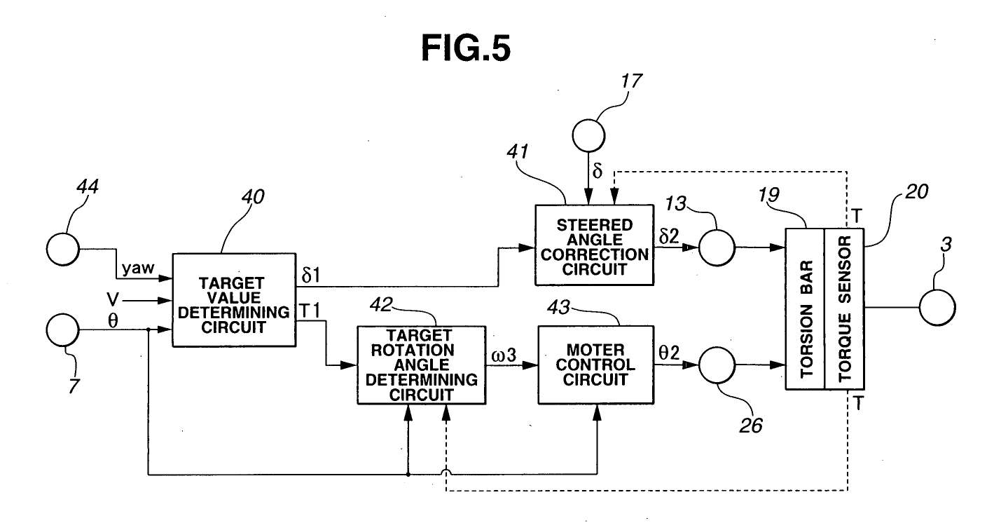

Referring to FIG. 5, there is shown a block diagram of a control unit employed in a second embodiment of the present invention.

As shown, in this second embodiment, for outputting steering angle target value “δ1” and steering reaction force target value “T1”, the target value determining circuit 40 of control unit 6 receives in addition to the above-mentioned vehicle speed signal “V” and steering angle signal “θ”, a yaw rate signal “yaw” that is detected by a yaw-rate sensor 44. Due to addition of new factor “yaw”, much precise control for the steering is expected.

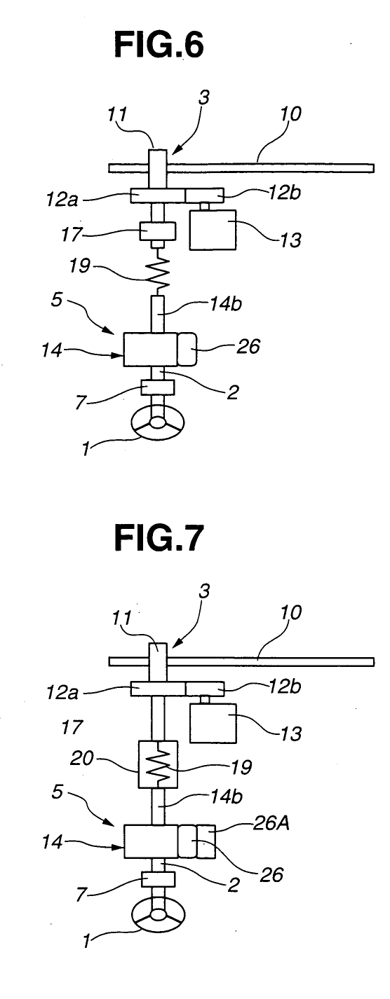

Referring to FIG. 6, there is shown but schematically a steer-by-wire type steering device to which a steering control system of a third embodiment of the present invention is practically applied.

In this embodiment, the steered angle sensor 17 arranged between torsion bar 19 and rack-and-pinion mechanism 3 is constructed to serve also as a torque sensor that detects a torsional moment (viz., torque) of torsion bar 19. It is to be noted that the torsional moment (or torque) applied to torsion bar 19 can be derived indirectly from the operation of rack-and-pinion mechanism 3 and the operation of electric motor 13.

Referring to FIG. 7, there is shown but schematically a steer-by-wire type steering device to which a steering control system of a fourth embodiment of the present invention is practically applied.

In this embodiment, a rotation angle sensor 26A that detects a rotation angle of electric motor 26 is employed. By processing information signal from the sensor 26A, the real steering angle can be indirectly derived. With employment of such rotation angle sensor 26A, detection of speed reduction ratio effected by planetary gear unit 14 is much assuredly obtained. Because the operation condition of electric motor 26 is directly detected by rotation angle sensor 26A, the electric motor 26 is much precisely controlled.

The entire contents of Japanese Patent Application 2003-200820 filed Jul. 24, 2003 are incorporated by reference.

Although the invention has been described above with reference to the embodiments of the invention, the invention is not limited to such embodiments as described above. Various modifications and variations of such embodiments may be carried out by those skilled in the art, in light of the above description.

1. A steering control system for controlling a turning movement of steered road wheels of a motor vehicle in accordance with a steering movement of a steering wheel, comprising:
a steering angle sensor that detects a steering angle by which the steering wheel is turned;
an actuator that turns the steered road wheels when operated;
a vehicle operation condition sensor that detects an operation condition of the motor vehicle;
a target value determining section that determines a steered angle target value of the steered road wheels in accordance with the steering angle detected by the steering angle sensor and the vehicle operation condition detected by the vehicle operation condition sensor; and
an actuator drive circuit that drives the actuator in accordance with the steered angle target value.

2. A steering control system as claimed in claim 1, further comprising a steered angle sensor that detects a steered angle of the steered road wheels, the target value determining section determining the steered angle target value of the steered road wheels in accordance with the steering angle detected by the steering angle sensor and the steered angle detected by the steered angle sensor.

3. A steering control system as claimed in claim 1, further comprising a back-up steering mechanism that is arranged between the steering wheel and the steered road wheels and operatively independent from the actuator, the back-up steering mechanism functioning to turn the steered road wheels in accordance with the turning of the steering wheel.

4. A steering control system as claimed in claim 3, further comprising:
an input shaft through which the steering wheel and the back-up steering mechanism are connected; and
an output shaft through which the back-up steering mechanism and the steered road wheels are connected.

5. A steering control system as claimed in claim 4, in which the back-up steering mechanism comprises:
a planetary gear unit having an input part connected to the input shaft and an output part connected to the output shaft; and
an operation mechanism by which rotation speed ratio between the input part and the output part is varied.

6. A steering control system as claimed in claim 5, further comprising an abnormal condition sensing means that detects an abnormal condition of the steering control system, and in which when the abnormal condition sensor senses an abnormal condition, a relative rotation between the input and output parts of the planetary gear unit is restricted.

7. A steering control system as claimed in claim 5, in which the operation mechanism comprises:
a worm gear formed on a ring gear of the planetary gear unit;
a worm shaft meshed with the worm gear;
an electric motor that drives the worm gear; and
an electric motor drive circuit that controls operation of the electric motor in accordance with the steered angle target value determined by the target value determining section.

8. A steering control system as claimed in claim 7, in which the operation mechanism stops rotation of the electric motor when the abnormal condition sensing means detects the abnormal condition of the steering control system.

9. A steering control system as claimed in claim 7, further comprising a torque sensor that is arranged between the back-up steering mechanism and the steered road wheels to detect a steering torque, the operation mechanism controlling the electric motor in accordance with the steering torque detected by the torque sensor.

10. A steering control system as claimed in claim 7, further comprising a rotation angle sensor that senses a rotation angle of the electric motor, the operating mechanism controlling the electric motor in accordance with the steering angle detected by the steering angle sensor and the rotation angle detected by the rotation angle sensor.

11. A steering control system as claimed in claim 3, further comprising a torque sensor that is arranged between the back-up steering mechanism and the steered road wheels to detect a steering torque, the actuator drive circuit controlling the actuator in accordance with the steering torque detected by the torque sensor.

12. A steering control system as claimed in claim 3, further comprising:
a torsion bar arranged between the back-up steering mechanism and the steered road wheels;
a real steering angle sensor that is arranged between the back-up steering mechanism and the torsion bar to detect a real steering angle;
a steered angle sensor that detects a steered angle by which the steered road wheels are turned; and
a control section that derives a twisted degree of the torsion bar based on both the real steering angle and steered angle and derives a steering torque from the twisted degree.

13. A steering control system as claimed in claim 12, further comprising a yaw rate sensor for sensing a yaw rate of the vehicle, the actuator drive circuit driving the actuator in accordance with the yaw rate detected by the yaw rate sensor.

14. A steering control system of a steer-by-wire type steering device, the steering device including an electric motor for turning steered road wheels of a motor vehicle, and a torsion bar operatively interposed between a steering wheel and the steered road wheels,
the steering control system comprising:
a vehicle speed sensor that detects a running speed of the vehicle;
a steering angle sensor that detects a steering angle by which a steering wheel of the vehicle is turned;
a steered angle sensor that detects a steered angle of steered road wheels of the vehicle;
a torque sensor that detects a torque applied to the torsion bar;
a first means that, by processing the running speed of the vehicle detected by the vehicle speed sensor and the steering angle detected by the steering angle sensor, outputs a target steered angle signal that represents a target value of steered angle of steered road wheels of the vehicle;
a second means that, by processing the target steered angle signal from the first means and the steered angle detected by the steered angle sensor, outputs a corrected steered angle signal that represents a corrected value of the steered angle of the steered road wheels of the vehicle, the corrected steered angle signal being fed to the electric motor for controlling the turning of the steered road wheels; and
a third means that, by processing the torque detected by the torque sensor, produces a steering reaction force that is to be applied to the steering wheel.

15. A steering control system as claimed in claim 14, further comprising a yaw rate sensor that detects a yaw rate of the vehicle, the first means processing the yaw rate for outputting the target steered angle signal.
